(19) United States
(12) Patent Application Publication
(10) Pub. No.: US 2008/0204398 A1
(43) Pub. Date: Aug. 28, 2008

(54) METHOD FOR DRIVING LAMPS, DRIVING CIRCUIT FOR PERFORMING THE SAME AND LIQUID CRYSTAL DISPLAY DEVICE HAVING THE SAME

(75) Inventors: Eui-Dong HWANG, Incheon (KR); Jae-Eun UM, Cheonan-si (KR); Pil-Nam LIM, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD, Suwon-si (KR)

(21) Appl. No.: 12/036,620

(22) Filed: Feb. 25, 2008

(30) Foreign Application Priority Data
Feb. 23, 2007 (KR) 10-2007-0018618

(51) Int. Cl. G02F 1/13357; G09G 3/36; H05B 41/36

(52) U.S. Cl. 345/102; 315/294

(57) ABSTRACT

A lamp driving circuit includes a power-generating section, a distribution sensing section and a feedback control section. The power-generating section generates a lamp driving power to drive a plurality of lamps. The distribution sensing section divides the lamp driving power to the plurality of lamps. The distribution sensing section senses the lamp driving power to generate a feedback signal. The feedback control section checks whether or not the plurality of lamps is lit. The feedback control section blocks the feedback signal from being reflected in the lamp driving power before the plurality of lamps is lit.

This application claims priority to Korean Patent Application No. 2007-18618, filed on Feb. 23, 2007, and all the benefits accruing therefrom under 35 U.S.C. §119, the contents of which in its entirety are herein incorporated by reference.

### BACKGROUND OF THE INVENTION

1. Field of the Invention

The present invention relates to a method for driving lamps, a driving circuit for performing the same and a liquid crystal display (“LCD”) device having the driving circuit. More particularly, the present invention relates to a method for driving lamps capable of preventing a lighting defect of a lamp, a driving circuit for performing the same and an LCD device having the driving circuit.

2. Description of the Related Art

Generally, an LCD device has characteristics, such as light weight, low power consumption, low driving voltage, etc., as compared with other types of display apparatuses, so that LCD devices are mainly used in monitors, notebook computers, cellular phones, etc. The LCD device includes an LCD panel for displaying images using a light transmission ratio of liquid crystal molecules and a backlight assembly disposed below the LCD panel to provide the LCD panel with light.

The backlight unit includes a lamp, such as a cold cathode fluorescent lamp (“CCFL”), and a direct current/alternating current (“DC/AC”) converter. The DC/AC converter converts a DC voltage into an AC voltage, and drives the lamp by generating a high voltage (or a strike voltage) using a transformer. In an initial driving of the lamp, the lamp requires the high strike voltage.

However, an input voltage of an inverter that provides the lamp with power may drop due to the strike voltage. When a peak power is increased during a period when the power is applied to the LCD device, the input voltage of the inverter may drop. An increase of the peak power is related to negative-resistance characteristics of the lamp. That is, an impedance of the lamp is increased when the power is applied to the lamp or due to the negative-resistance characteristics of the lamp, so that the peak power that is applied to the lamp is thereby increased.

When an input voltage of the inverter is dropped, a protection circuit for protecting the lamp is activated so that the lamp is immediately turned off. That is, even though the LCD device does not have any particular problems, the lamp may be turned off due to a drop of the input voltage of an inverter.

### BRIEF SUMMARY OF THE INVENTION

The present invention provides a method for driving a lamp capable of preventing a lighting defect which is generated in the lamp requiring a high strike voltage in an initial driving of the lamp.

The present invention also provides a driving circuit for performing the above-mentioned method.

The present invention also provides a liquid crystal display (“LCD”) device having the above-mentioned driving circuit.

In an exemplary embodiment of the present invention, there is provided a method for driving a lamp. A plurality of lamps is provided with a lamp driving power. Then, the lamp driving power is sensed to generate a feedback signal. Then, it is checked whether or not the plurality of lamps is lit. Then, the feedback signal is blocked from being reflected in the lamp driving power before the plurality of lamps is lit.

In another exemplary embodiment of the present invention, a lamp driving circuit includes a power-generating section, a distribution sensing section and a feedback control section. The power-generating section generates a lamp driving power to drive a plurality of lamps. The distribution sensing section divides the lamp driving power to the plurality of lamps. The distribution sensing section senses the lamp driving power to generate a feedback signal. The feedback control section checks whether or not the plurality of lamps is lit. The feedback control section blocks the feedback signal from being reflected in the lamp driving power before the plurality of lamps is lit.

In still another exemplary embodiment of the present invention, an LCD apparatus includes an LCD panel and a backlight unit. The LCD panel displays an image using a liquid crystal layer interposed between two substrates. The backlight unit includes a plurality of lamps which provide the LCD panel with light in response to a lamp driving power and a lamp driving circuit which blocks an outputting of a feedback signal which controls an outputting of the lamp driving power before the plurality of lamps is lit.

According to the exemplary embodiment of a method for driving lamps, the exemplary embodiment of the driving circuit for performing the method and the exemplary embodiment of the LCD device having the driving circuit, a feedback signal which controls an output of a lamp driving power which is provided to the plurality of lamps is delayed before the plurality of lamps are fully turned on, such that a lighting defect may be prevented or substantially reduced, which is generated in the lamps requiring a high strike voltage during an initial driving of the lamps.

### BRIEF DESCRIPTION OF THE DRAWINGS

The above and/or other aspects, features and advantages of the present invention will now become readily apparent by reference to the following detailed description when considered in conjunction with the accompanying drawings, in which:

FIG. 1 is a block diagram illustrating an exemplary embodiment of a backlight unit according to the present invention;

FIG. 2 is an equivalent circuit schematic diagram illustrating a portion of an exemplary embodiment of an output terminal of the power-generating section of FIG. 1;

FIG. 3 is an equivalent circuit schematic diagram illustrating an exemplary embodiment of the distribution sensing section of FIG. 1;

FIG. 4 is an equivalent circuit schematic diagram illustrating an exemplary embodiment of the feedback control section of FIG. 1;

FIG. 5 is an equivalent circuit schematic diagram illustrating an exemplary embodiment of a shunt regulator of FIG. 4;

FIG. 6 is a flow chart illustrating an exemplary embodiment of a lamp driving method according to the present invention;

FIG. 7 is a flow chart illustrating an exemplary embodiment of a step which checks whether the lamps are fully turned on or not in FIG. 6; and

FIG. 8 is a block diagram illustrating an exemplary embodiment of a liquid crystal display (“LCD”) device according to the present invention.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, regions, integers, steps, operations, elements, and/or components, but do not preclude the presence or addition of one or more other features, regions, integers, steps, operations, elements, components, and/or groups thereof.

Exemplary embodiments of the present invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, exemplary embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, the present invention will be described in detail with reference to the accompanying drawings.

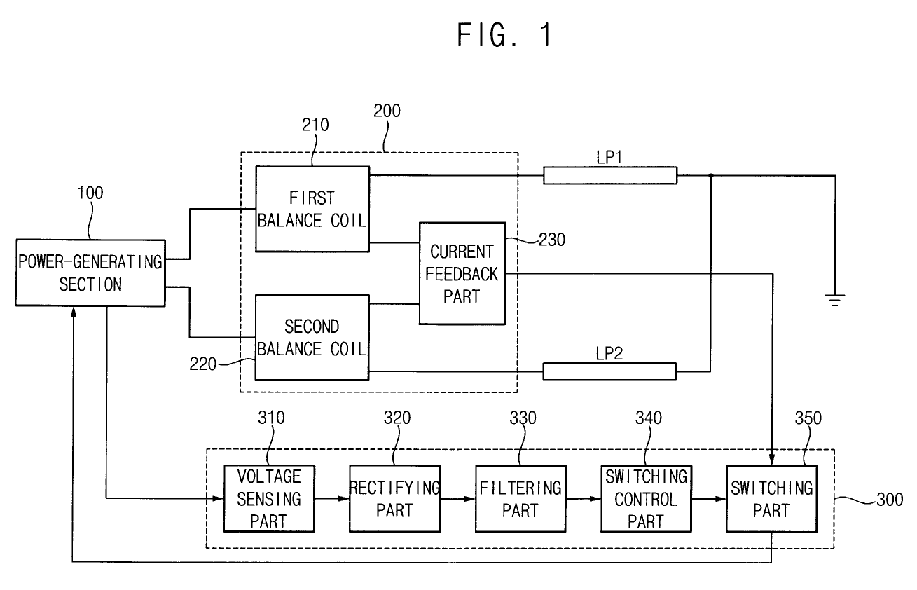

FIG. 1 is a block diagram illustrating an exemplary embodiment of a backlight unit according to the present invention.

Referring to FIG. 1, a backlight unit according to an exemplary embodiment of the present invention includes a power-generating section 100, a distribution sensing section 200, a feedback control section 300, a first lamp LP1 and a second lamp LP2. The power-generating section 100 in exemplary embodiments, the distribution sensing section 200 and the feedback control section 300 may define a lamp-driving circuit for driving the first and second lamps LP1 and LP2.

The power-generating section 100 provides the distribution sensing section 200 with a lamp driving power for driving the first and second lamps LP1 and LP2.

The distribution sensing section 200 includes a first balance coil 210, a second balance coil 220 and a current feedback part 230. The distribution sensing section 200 provides the first and second lamps LP1 and LP2, respectively, with the lamp driving power provided from the power-generating section 100. The distribution sensing section 200 senses the lamp driving power provided from the power-generating section 100, and generates a feedback signal which controls an output of the lamp driving power to provide the feedback control section 300 with the feedback signal. The first balance coil 210 is electrically connected to the first lamp LP1, and the second balance coil 220 is electrically connected to the second lamp LP2.

The feedback signal is used in order to apply a uniform lamp driving power to the first and second lamps LP1 and LP2. The feedback signal is used such that an overcurrent is not applied to the first and second lamps LP1 and LP2. For example, if the overcurrent is applied to the first and second lamps LP1 and LP2, lifetimes of the first and second lamps LP1 and LP2 may be thereby decreased. Therefore, when the feedback signal is applied to a protection circuit (not shown) of the power-generating section 100, the protection circuit limits an output of the lamp driving power or decreases a level of the lamp driving power. As a result, damage to the first and second lamps LP1 and LP2 may be prevented or substantially reduced.

The feedback control section 300 includes a voltage sensing part 310, a rectifying part 320, a filtering part 330, a switching control part 340 and a switching part 350. The feedback control section 300 prevents a providing of the feedback signal until the first and second lamps LP1 and LP2 are fully lit, and provides the power-generating section 100 with the feedback signal when the first and second lamps LP1 and LP2 are fully lit.

In exemplary embodiments, the voltage sensing part 310 senses the lamp driving power outputted from the power-generating section 100. The rectifying part 320 rectifies the sensed lamp driving power, and provides the filtering part 330 with the rectified lamp driving power. In an exemplary embodiment, the rectifying part 320 half-wave rectifies the sensed lamp driving power. The filtering part 330 filters the rectified lamp driving power into a direct current (“DC”) voltage, and provides the switching control part 340 with the filtered DC voltage. The switching control part 340 provides the switching part 350 with a switching control signal when the filtered DC voltage approaches a predetermined level. The switching part 350 is electrically connected to an output terminal of the distribution sensing section 200, and allows an outputting of the feedback signal based on the switching control signal.

Each first terminal of the first and second lamps LP1 and LP2 is electrically connected to the distribution sensing section 200, respectively, and each second terminal of the first and second lamps LP1 and LP2 is electrically connected to a ground potential, respectively.

As described above, the providing of the feedback signal is delayed before the first and second lamps LP1 and LP2 are fully turned on. In exemplary embodiments, the feedback signal may convert an input duty cycle into a normal operation duty cycle. Then, the feedback signal may be applied to the power-generating section 100 after the first and second lamps LP1 and LP2 are fully turned on, such that a lighting defect of the first and second lamps LP1 and LP2 requiring the high strike voltage may be prevented or substantially reduced.

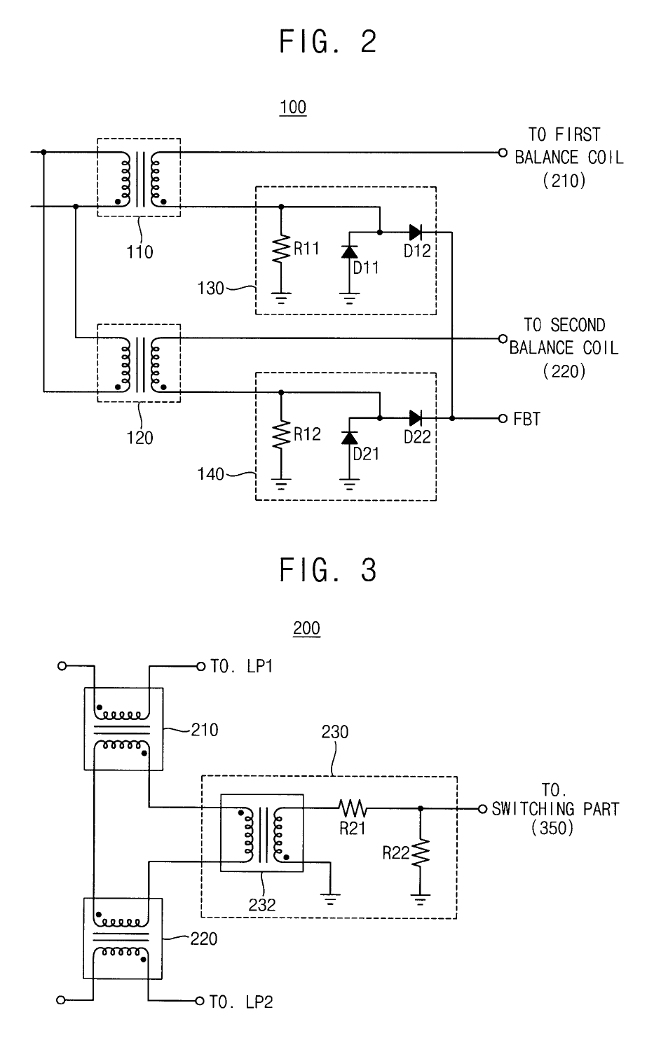

FIG. 2 is an equivalent circuit schematic diagram illustrating a portion of an exemplary embodiment of an output terminal of a power-generating section 100 of FIG. 1.

Referring to FIGS. 1 and 2, the power-generating section 100 according to an exemplary embodiment of the present invention includes a first boosting part 110, a second boosting part 120, a first sensing part 130 and a second sensing part 140.

The first boosting part 110 includes a first transformer including a primary winding and a secondary winding, which are each wound in a same direction, and the first boosting part 110 provides the first balance coil 210 with a boosted lamp driving power through a first side of the secondary winding. Therefore, the lamp driving power with a same polarity as that which is applied to the first boosting part 110 is applied to the first balance coil 210.

The second boosting part 120 includes a second transformer including a primary winding and a secondary winding which are wound in a same direction, and the second boosting part 120 provides the second balance coil 220 with a boosted lamp driving power through a first side of the secondary winding. Therefore, the lamp driving power with a same polarity as that which is applied to the second boosting part 120 is applied to the second balance coil 220.

The first sensing part 130 includes a first resistor R11, a first diode D11 and a second diode D12. The first sensing part 130 is electrically connected to a second side of the secondary winding of the first transformer to generate a voltage which is applied to the first balance coil 210 as an inner feedback signal.

In an exemplary embodiment, a first terminal of the first resistor R11 is electrically connected to the secondary winding of the first transformer, and a second terminal of the first resistor R11 is electrically connected to a ground potential. A cathode of the first diode D11 is electrically connected to a first end of the first resistor R11, and an anode of the first diode D11 is electrically connected to the ground potential. An anode of the second diode D12 is electrically connected to the cathode of the first diode D11, and a cathode of the second diode D12 outputs the inner feedback signal. In the current exemplary embodiment, the inner feedback signal is used to control the lamp driving power outputted from the power-generating section 100.

The second sensing part 140 includes a second resistor R12, a third diode D21 and a fourth diode D22. The second sensing part 140 is electrically connected to a second side of the secondary winding of the second transformer to generate a voltage which is applied to the second balance coil 220 as the inner feedback signal. In an exemplary embodiment, the second resistor R12 includes a first terminal electrically connected to the secondary winding of the second transformer, and a second terminal electrically connected to a ground potential. The third diode D21 includes a cathode electrically connected to the first terminal of the second resistor R12 and an anode electrically connected the ground potential. The fourth diode D22 includes an anode electrically connected to the cathode of the third diode D21 and a cathode which outputs the inner feedback signal.

FIG. 3 is an equivalent circuit schematic diagram illustrating the exemplary embodiment of a distribution sensing section 200 of FIG. 1.

Referring to FIGS. 1 and 3, the distribution sensing section 200 according to an exemplary embodiment of the present invention includes a first balance coil 210, a second balance coil 220 and a current feedback part 230. The first balance coil 210 is electrically connected between the power-generating section 100 and a first lamp LP1. The second balance coil 220 is electrically connected between the power-generating section 100 and a second lamp LP2. The current feedback part 230 is electrically connected between the first balance coil 210 and the second balance coil 220.

A first terminal of the first balance coil 210 is disposed to face a first terminal of the second balance coil 220. A polarity of a first terminal of the first balance coil 210 is opposite to a polarity corresponding to a first terminal of the second balance coil 220. Accordingly, when a positive polarity lamp driving power and a negative polarity lamp driving power are applied to the first balance coil 210 and the second balance coil 220, respectively, a negative polarity lamp driving power and positive polarity lamp driving power are applied to the first lamp LP1 and the second lamp LP2, respectively.

The second balance coil 220 and the first balance coil 210 will be denoted as a normal coil and a reverse coil with respect to the current feedback part 230, respectively. In the current exemplary embodiment, a winding ratio between the reverse coil and the normal coil is about 26:1,040.

The current feedback part 230 includes a current coil 232 electrically connected to the secondary winding of the first balance coil 21 0 and the secondary coil of the second balance coil 220, and a voltage sensing part electrically connected to the secondary winding of the current coil 232 to generate the feedback signal. The voltage sensing part includes a third resistor R21 and a fourth resistor R22.

The current coil 232 includes a primary winding electrically connected to each secondary winding of the first and second balance coils 210 and 220, and a secondary winding electrically connected to the voltage sensing part and a ground terminal. In the current exemplary embodiment, a winding direction of the primary winding of the current coil 232 is different from that of the secondary winding of the current coil 232. In the current exemplary embodiment, a winding ratio between the primary winding and the secondary winding of the current coil 232 is about 29:58.

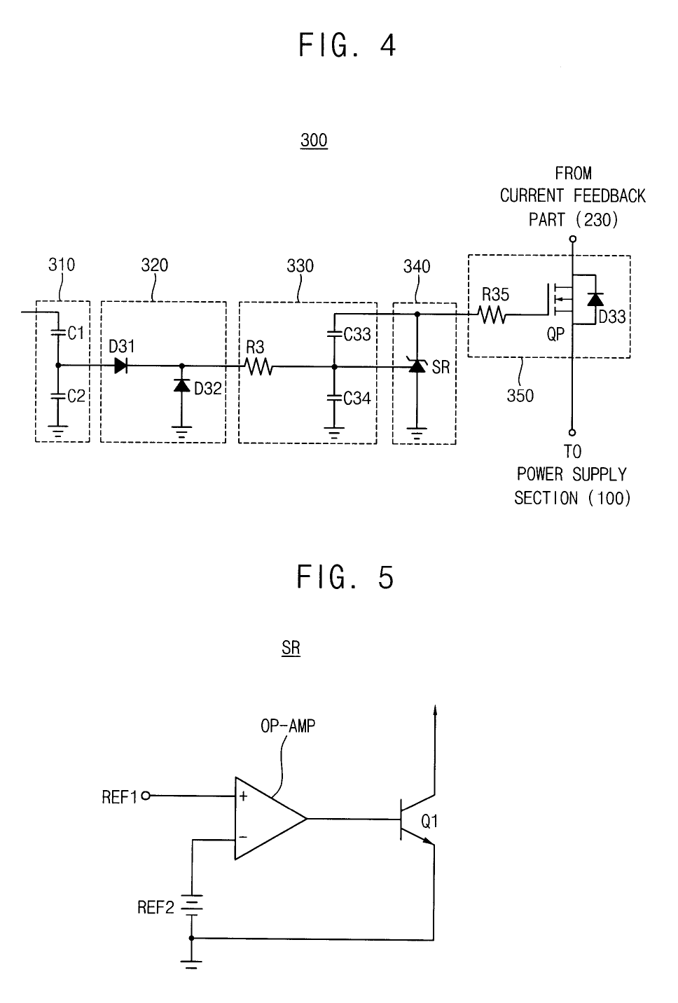

FIG. 4 is an equivalent circuit schematic diagram illustrating an exemplary embodiment of the feedback control section of FIG. 1. FIG. 5 is an equivalent circuit schematic diagram illustrating an exemplary embodiment of the shunt regulator of FIG. 4.

Referring to FIG. 4, a feedback control section 300 according to an exemplary embodiment of the present invention includes a voltage sensing part 310, a rectifying part 320, a filtering part 330, a switching control part 340 and a switching part 350.

The voltage sensing part 310 includes a first capacitor C1 and a second capacitor C2. In exemplary embodiments, the first and second capacitor C1 and C2 may be connected in series. The lamp driving power is distributed and sensed by the voltage sensing part 310 when the backlight unit is activated.

The rectifying part 320 includes a fifth diode D31 and a sixth diode D32, and rectifies the sensed lamp driving power. In exemplary embodiments, a cathode of the fifth diode D31 is electrically connected to a cathode of the sixth diode D32, and an anode of the sixth diode D32 is electrically connected to a ground potential.

The filtering part 330 includes a fifth resistor R3, a third capacitor C33 and a fourth capacitor C34, and the filtering part 330 filters the rectified lamp driving power into a DC voltage.

The switching control part 340 includes a shunt regulator SR, and outputs a switching control signal when the filtered DC voltage reaches a predetermined level.

Referring to FIG. 5, when the fourth capacitor C34 is charged, a cathode of the shunt regulator SR includes a low level. In an exemplary embodiment, when a voltage of no more than about 2.5 V is charged in the fourth capacitor C34, a cathode of the shunt regulator SR includes a low level.

The switching part 350 includes sixth resistor R35, a metal-oxide semiconductor (“MOS”) transistor QP and a diode D33. The switching part 350 is electrically connected to an output terminal of the distribution sensing section 200, and the switching part 350 allows an outputting of the feedback signal based on the switching control signal.

In an exemplary embodiment, for example, the MOS transistor QP includes a first electrode electrically connected to a sixth resistor R35 which is electrically connected to an output terminal of the distribution sensing section 200, a second electrode which is electrically connected to the power-generating section 100 and a control electrode which is electrically connected to an output terminal of the distribution sensing section 200. In exemplary embodiments, the MOS transistor QP may include a p-type MOS (“PMOS”), which is turned on when a voltage which is applied to the control electrode is at a low level. The diode D33 is connected in parallel with the MOS transistor QP in order to block a reverse current.

In an operation, when a cathode of the shunt regulator SR is at a low level, the MOS transistor QP is turned on and the feedback signal which is outputted from the current coil 232 is delivered to the power-generating section 100. In the current exemplary embodiment, during a charging time of the fourth capacitor C34, the feedback signal is delayed and then delivered to the power-generating section 100.

When the charging time of the fourth capacitor C34 is about 1 second to about 2 seconds, a delay time of the feedback signal is about 1 second to about 2 seconds. In exemplary embodiments, for example, since a resistor R and a capacitor C define a time constant t (e.g., t=RC), a control of the delay time is possible in accordance with a control of the fifth resistor R3 and the fourth capacitor C34.

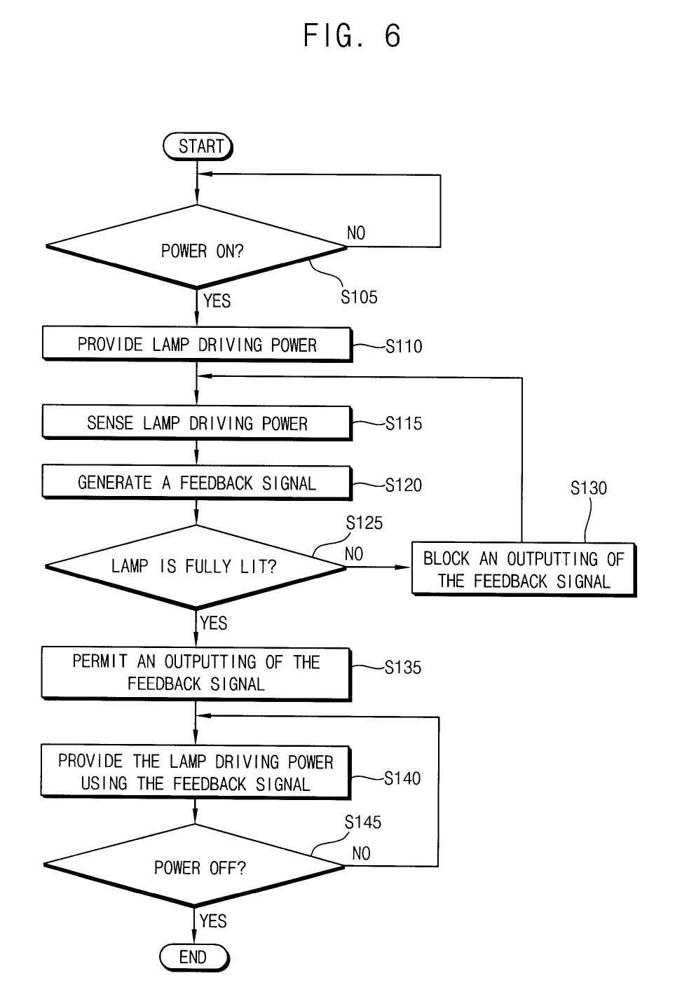

FIG. 6 is a flow chart illustrating an exemplary embodiment of a lamp driving method according to the present invention.

Referring to FIGS. 1 and 6, when a power is provided to the backlight unit (step S105), the power-generating section 100 generates a lamp driving power for driving lamps. The power-generating section 100 provides the first and second lamps LP1 and LP2, respectively, with the generated lamp driving power through the distribution sensing section 200 (step S110).

Then, the lamp driving power provided to the first and second lamps LP1 and LP2 is sensed (step S115), and then a feedback signal corresponding to the sensed lamp driving power is generated (step S120).

Then, whether or not the first and second lamps LP1 and LP2 are fully lit is checked (step S125).

In step S125, when the first and second lamps LP1 and LP2 are not fully lit, the feedback signal is blocked from flowing to the power-generating section 100 (step S130), and the lamp driving process is then fed back to step S115.

In step S125, when the first and second lamps LP1 and LP2 are fully lit, an outputting of the feedback signal is permitted (step S135), and then the lamp driving power is provided to the first and second lamps LP1 and LP2, respectively, using the feedback signal (step S140). When the first and second lamps LP1 and LP2 are fully lit, the feedback signal is reflected in the lamp driving power which is provided to the first and second lamps LP1 and LP2. Therefore, a uniform lamp driving power is applied to the first and second lamps LP1 and LP2.

Then, whether or not the power source is turned off is checked (step S145). The lamp driving process is ended when the power source is turned off, and alternatively, the lamp driving process returns back to step S140 when the power source is not turned off.

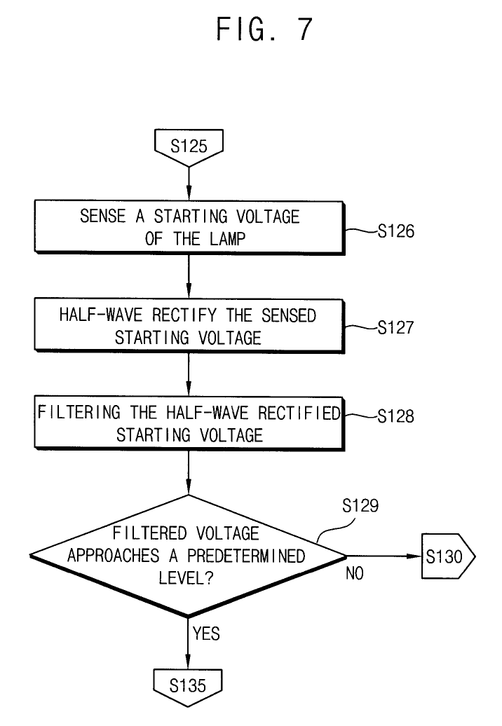

FIG. 7 is a flow chart illustrating an exemplary embodiment of a step which checks whether the lamps are fully turned on or not in FIG. 6.

Referring to FIGS. 1 through 7, the voltage sensing part 310 including the first and second capacitors C1 and C2 senses a starting voltage provided to the first and second lamps LP1 and LP2, when the backlight unit is turned on (step S126).

Then, the rectifying part 320, including the fifth and sixth diodes D31 and D32, half-wave rectifies the sensed starting voltage (step S127).

Then, the filtering part 330 including the fifth resistor R3, and third and fourth capacitors C33 and C34 filters the half-wave rectified starting voltage (step S128).

Then, the switching control part 340 including the shunt-regulator SR checks whether the filtered voltage has reached a predetermined level or not (step S129). In an exemplary embodiment, for example, when the filtered voltage has reached the predetermined level, a cathode of the shunt regulator SR may have a low level.

In step S129, step S130 is performed when the filtered voltage has not reached the predetermined level, and step S135 is performed when the filtered voltage has reached the predetermined level.

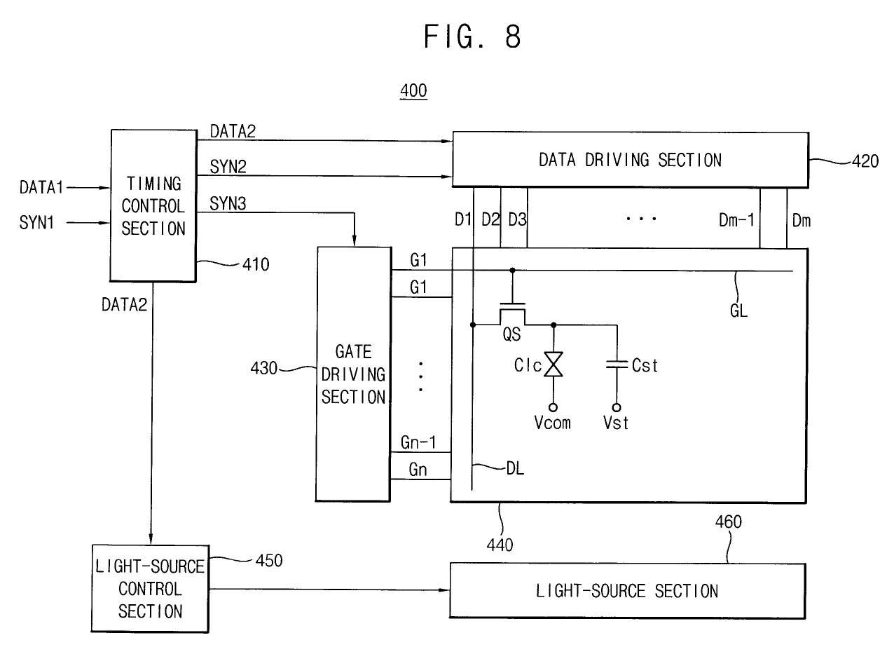

FIG. 8 is a block diagram illustrating an exemplary embodiment of a liquid crystal display (“LCD”) device according to the present invention.

Referring to FIG. 8, an exemplary embodiment of an LCD apparatus 400 according to the present invention includes a timing control section 410, a data driving section 420, a gate driving section 430, an LCD panel 440, a light-source control section 450 and a light-source section 460. The timing control section 410, the data driving section 420 and the gate driving section 430 define an image signal processing section which provides the LCD panel 440 with image data provided from an external device (not shown), such as a graphic controller. The light-source control section 450 and a light-source section 460 define a backlight apparatus which provides light to the LCD panel 440, which displays an image using liquid crystal molecules.

The timing control section 410 receives a first image data DATA1 and a first synchronization signal SYN1 from an external device, such as a graphic controller, and outputs a second image data DATA2 and a second synchronization signal SYN2 to the data driving section 420. The timing control section 410 outputs a third synchronization signal SYN3 and the second image data DATA2 to the gate driving section 430 and the light-source control section 450, respectively. In exemplary embodiments, the first synchronizing signal SYN1 may include a vertical synchronizing signal (Vsync), a horizontal synchronizing signal (Hsync), a main clock signal (MCLK) and a data enable signal (DE). The vertical synchronizing signal (Vsync) represents a time required for displaying one frame. The horizontal synchronizing signal (Hsync) represents a time required for displaying one line of the one frame. Thus, the horizontal synchronizing signal includes pulses corresponding to the number of pixels included in one line. The data enable signal (DE) represents a time required for supplying the pixel with data. In exemplary embodiments, the second synchronizing signal SYN2 may include a load signal (LOAD), a horizontal start signal (STH) and a polarity control signal (REV) for outputting the second data signal DATA2. In an exemplary embodiment, the polarity control signal REV may control a polarity of the second image data DATA2. In further exemplary embodiments, the third synchronizing signal SYN3 may include a gate clock signal (CPV or GCLK) and a vertical start signal (STV).

The data driving section 420 outputs a plurality of data signals D1, D2, . . . , Dm-1 and Dm to the LCD panel 440 based on the second image data DATA2 and the second synchronization signal SYN2. The timing control section 410 and the data driving section 420 are separately described in logical terms for ease of understanding, whether or not they are separate physical hardware elements. That is, the present invention is not limited to a separate timing control section 41 0 and a separate data driving section 420.

The gate driving section 430 outputs gate signals G1, G2, . . . , Gn-1 and Gn to the LCD panel 440 based on the third synchronization signal SYN3. In the current exemplary embodiment, ‘n’ denotes a natural number.

The LCD panel 440 displays images using liquid crystal molecules which are disposed between two substrates. Particularly, the LCD panel 440 includes a plurality of data lines DL, a plurality of gate lines GL and a switching element QS, which is formed in an area defined by the data lines and the gate lines, respectively. However, the present invention is not limited to thereof LCD panels 440. In exemplary embodiments, the switching QS may include a thin-film transistor (“TFT”).

The data lines DL extend substantially along a first direction, such as a vertical direction. The data lines DL transfer a plurality of data signals D1 to Dm to the switching element QS. The gate lines GL extend substantially along a second direction, such as a horizontal direction. In exemplary embodiments, the second direction is substantially perpendicular to the first direction. The gate lines GL sequentially transfer a plurality of gate signals G1 to Gn to the switching element QS. The gate signals G1 to Gn include a voltage level for turning on/off the switching element QS.

In exemplary embodiments, the switching element QS may include a source electrode, a gate electrode and a drain electrode. The source electrode is electrically connected to the data line DL, such that the source electrode receives the data signal. The gate electrode is electrically connected to the gate line GL, such that the gate electrode receives the gate signal. The drain electrode is electrically connected to a liquid crystal capacitor Clc and a storage capacitor Cst.

The light-source control section 450 provides the light-source section 460 with the lamp driving power when a power source is turned on, and provides the light-source section 460 with the lamp driving power using a feedback signal controlling an output of the lamp driving power after the light-source section 460 is fully turned on. In the current exemplary embodiment, the feedback signal is used to apply a uniform lamp driving power to the lamps of the light-source section 460.

In exemplary embodiments, the light-source control section 450 may be defined by the power-generating section 100, the distribution sensing section 200 and the feedback control section 300 as shown in FIG. 1.

In an exemplary embodiment, for example, the light-source control section 450 provides the light-source section 460 with the lamp driving power, which is not reflected in the feedback signal, before the light-source section 460 is not fully turned on. When the light-source section 460 is fully turned on, the lamp driving power which is reflected in the feedback signal is provided to the light-source section 460. Therefore, a lighting defect of the light-source section 460, which requires the high strike voltage during an initial driving of the light-source section 460, may be prevented or substantially reduced.

The light-source section 460 includes a plurality of lamps, and the light-source section 460 provides the LCD panel 440 with light based on the lamp driving power provided from the light control section 450. In an operation, the light-source section 460 emits light based on the lamp driving power which is not reflected in the feedback signal during an initial driving of the lamps, and the light-source section 460 emits light based on the lamp driving power which is reflected in the feedback signal after the plurality of lamps are fully lit.

As described above, according to the present invention, a providing of a feedback signal is delayed before lamps are fully turned on to prevent a conversion of an input duty cycle into a normal operation duty cycle by the feedback signal, such that a lighting defect generated in the plurality of lamps requiring a high strike voltage may be prevented or substantially reduced.

Although some exemplary embodiments of the present invention have been described, it is understood that the present invention should not be limited to these exemplary embodiments but various changes and modifications can be made by one of ordinary skill in the art within the spirit and scope of the present invention as hereinafter claimed.

What is claimed is:

1. A method for driving a lamp, the method comprising:
providing a plurality of lamps with a lamp driving power;
sensing the lamp driving power to generate a feedback signal;
checking whether or not the plurality of lamps is lit; and
blocking the feedback signal from being reflected in the lamp driving power before the plurality of lamps is lit.

2. The method of claim 1, wherein the checking whether or not the plurality of lamps is lit comprises:
sensing the lamp driving power;
rectifying the sensed lamp driving power;
filtering the rectified lamp driving power into a direct current voltage;
checking whether or not the filtered direct current voltage has reached a predetermined level; and
determining whether the plurality of lamps is lit when the filtered direct current voltage reaches the predetermined level.

3. The method of claim 1, further comprising providing the plurality of lamps with the lamp driving power using the feedback signal when the plurality of lamps is lit.

4. A lamp diving circuit comprising:
a power-generating section which generates a lamp driving power to drive a plurality of lamps;
a distribution sensing section which divides the lamp driving power to the plurality of lamps, the distribution sensing section senses the lamp driving power to generate a feedback signal; and
a feedback control section which checks whether or not the plurality of lamps is lit, the feedback control section blocks the feedback signal from being reflected in the lamp driving power before the plurality of lamps is lit.

5. The lamp diving circuit of claim 4, wherein the power-generating section generates the lamp driving power using the feedback signal in accordance with an application of the feedback signal by the feedback control section.

6. The lamp diving circuit of claim 4, wherein the feedback control section comprises:
a voltage sensing part which senses the lamp driving power;
a rectifying part which rectifies the sensed lamp driving power;
a filtering part which filters the rectified lamp driving power into a direct current voltage;
a switching control part which outputs a switching control signal when the filtered direct current voltage reaches a predetermined level; and
a switching part which provides the power-generating section with the feedback signal which is outputted from the distribution sensing section based on the switching control signal.

7. The lamp diving circuit of claim 6, wherein the switching control part comprises a shunt regulator varied to a low level to output the switching control signal when the filtered direct current voltage reaches the predetermined level.

8. The lamp diving circuit of claim 6, wherein the switching part comprises a metal-oxide semiconductor transistor comprising a first electrode electrically connected to an output terminal of the distribution sensing section, a second electrode electrically connected to the power-generating section and a control electrode electrically connected to the output terminal of the distribution sensing section.

9. The lamp diving circuit of claim 8, wherein the metal-oxide semiconductor transistor comprises a p-type metal-oxide semiconductor transistor.

10. The lamp diving circuit of claim 8, wherein the switching part further comprises a diode which is connected in parallel with the metal-oxide semiconductor to block a countercurrent.

11. The lamp diving circuit of claim 6, wherein the rectifying part half-wave rectifies a starting voltage.

12. The lamp diving circuit of claim 4, wherein the distributing-sensing part comprises:
a first balance coil electrically connected between the power-generating section and a first lamp;
a second balance coil electrically connected between the power-generating section and a second lamp; and
a current feedback part electrically connected between the first balance coil and the second balance coil.

13. The lamp diving circuit of claim 1 2, wherein a first terminal of the first balance coil is disposed to face a first terminal of the second balance coil, and
a polarity of the first terminal of the first balance coil is opposite to a polarity of the first terminal of the second balance coil.

14. The lamp diving circuit of claim 12, wherein the current feedback part comprises:
a current coil electrically connected to a secondary winding of the first balance coil and a secondary winding of the second balance coil; and
a voltage sensing part electrically connected to a secondary winding of the current coil to generate the feedback signal.

15. The lamp diving circuit of claim 14, wherein the current coil comprises:
a primary winding electrically connected to each of secondary windings of the first and second balance coils, respectively; and
a secondary winding electrically connected to the voltage sensing part and the ground terminal, the secondary winding including a different winding direction from a winding direction of the primary winding.

16. A liquid crystal display apparatus comprising:
a liquid crystal display panel which displays an image using a liquid crystal layer interposed between two substrates; and
a backlight unit comprising a plurality of lamps which provide the liquid crystal display panel with light in response to a lamp driving power, and a lamp driving circuit which blocks an outputting of a feedback signal which controls an outputting of the lamp driving power before the plurality of lamps is lit.

17. The liquid crystal display apparatus of claim 16, wherein the lamp driving circuit comprises:
a power-generating section which generates the lamp driving power;
a distribution sensing section which divides the lamp driving power to the plurality of lamps, the distribution sensing section which senses the lamp driving power to generate a feedback signal; and
a feedback control section which provides the power-generating section with the feedback signal when the plurality of lamps is lit.

18. The liquid crystal display apparatus of claim 17, wherein the feedback control section comprises:
a voltage sensing part which senses the lamp driving power;
a rectifying part which rectifies the sensed lamp driving power;
a filtering part which filters the rectified lamp driving power into a direct current voltage;
a switching control part which outputs a switching control signal when the filtered direct current voltage reaches a predetermined level; and
a switching part which provides the power-generating section with the feedback signal outputted from the distribution sensing section based on the switching control signal.

19. The liquid crystal display apparatus of claim 16, wherein each lamp of the plurality of lamps comprises a first terminal electrically connected to an output terminal of the distribution sensing section, and each lamp of the plurality of lamps comprises a second terminal electrically connected to a ground potential.

20. The liquid crystal display apparatus of claim 19, wherein the distribution sensing section applies a lamp driving power of different phases to different lamps of the plurality of lamps.

21. The liquid crystal display apparatus of claim 20, wherein the distribution sensing section comprises a plurality of balance coils with different winding directions, the plurality of balance coils electrically connected to the different lamps of the plurality of lamps.

22. The liquid crystal display apparatus of claim 16, wherein the lamp driving circuit provides the plurality of lamps with the lamp driving power, and the plurality of lamps are connected in parallel with each other.
